(19) United States
(12) Patent Application Publication
(10) Pub. No.: US 2024/0181451 A1
(43) Pub. Date: Jun. 6, 2024

(54) MICROFLUIDIC SYSTEM AND METHOD

(71) Applicant: KROMEK LIMITED

(72) Inventors: Alexander Thomas Machin, Sedgefield (GB); Stuart James Marsay, Sedgefield (GB); Andrew Duncan Wood, Sedgefield (GB)

(21) Appl. No.: 18/553,286

(22) PCT Filed: Apr. 8, 2022
(86) PCT No.: PCT/GB2022/050889

§ 371 Date: Sep. 29, 2023

(30) Foreign Application Priority Data
Apr. 8, 2021 (GB) 2105032.3

(51) Int. Cl. B01L 3/00

(52) U.S. Cl. CPC B01L 3/50273; B01L 2200/0621; B01L 2300/087; B01L 2300/18; B01L 2400/0487; B01L 2400/0644; B01L 2400/0694

(57) ABSTRACT

A microfluidic system is described comprising a plurality of fluidly connected microfluidic chambers, each microfluidic chamber comprising: a fluid sample inlet; a fluid sample outlet; a selectably closable valve operable to enable gas to be vented from the chamber; a pressurisation system operable to apply an overpressure to one or more first microfluidic chambers being fluidly most upstream. A method is also described comprising supplying a fluid sample to the system via the one or more first microfluidic chambers being fluidly most upstream; operating the pressurisation system to apply an overpressure to the one or more first microfluidic chambers; selectively operating the valves of the fluidly connected microfluidic chambers to cause the fluid sample to move successively between the microfluidic chambers.

The invention relates to a microfluidic system and method. The invention in particular relates to the microfluidic processing of a liquid sample such as an aqueous sample successively through plural microfluidic reactors having different functions.

The invention finds particular applicability in relation to the processing for analysis and optionally further the analysis of collected chemical or biological samples away from a dedicated laboratory facility, and for example in close spatial or temporal proximity to a sample collection site, and for example in-line with a collection system. The invention finds particular applicability in relation to the processing and analysis of collected airborne chemical or biological species, for example to identify airborne hazards. The invention finds particular applicability to the processing for analysis and optionally further the analysis of biological samples, and for example the processing of samples comprising genetic material and optionally further the analysis of genetic material by sequencing.

### INTRODUCTION

Laboratory based technology for analysis of both chemical and biological materials is relatively well established. For laboratory application, a batch processing methodology is typically followed where samples are collected in the field and sent to the laboratory for analysis. The efficient and effective collection of samples for subsequent analysis, and in particular the collection of sufficient concentrations of any target chemical or biological species for that subsequent analysis is always desirable.

The invention in particular concerns the collection of chemical and biological materials in a target environment away from such a laboratory, for example to monitor environmental conditions, and for example concerns the collection airborne chemical or biological species to monitor air quality and/or detect chemical or biological hazards.

Batch processing of samples collected from distributed locations in a conventional laboratory may be inefficient and slow. Particular advantages can accrue if the processing for analysis and optionally further the analysis of collected chemical or biological samples can be at least partly automated and/or adapted to be performed away from a dedicated laboratory facility. Particular advantages can accrue if these steps can be performed in close spatial or temporal proximity to a sample collection site, and for example in-line with a collection system.

For these and other reasons, microfluidic “lab-on-chip” systems find increasing application in relation to the processing for analysis and the analysis of chemical or biological samples in a range of scenarios where such processing might create advantages over conventional full scale laboratory analysis, including but not limited to those discussed above.

In general terms, microfluidics is an established concept and the skilled person would readily appreciate the difference between the microfluidic conformance of the systems to which applicant's invention and larger scale laboratory batch process modules. Microfluidic systems include as will be familiar systems that manipulate and transport, mix, separate, or otherwise process low volumes of fluids on a small (typically sub millimetre) scale, to provide a partial or complete solution based partially or fully on lab-on-chip principles. Microfluidics is thus an important technology which allows lab-on-chip concepts to be effected.

When processing chemical and biological samples, numerous process often take place on the sample. Different processes often require different hardware to be carried out. In a microfluidics system which contains a series of process steps in different processing modules, it is necessary to transport the fluid between each module in a timely and efficient manner which does not degrade the sample.

There are numerous challenges to be overcome when transporting the fluid sample. The viscosity of the sample can require a sufficiently large force to transport the fluid through all of the steps. Altering the characteristics of one step will affect the forces applied on other steps, thus making all components interdependent and difficult to optimise.

One consequence of these challenges is the difficulty in knowing when the fluid has reached a stage in the microfluidics process. Different pressure drops across different stages means that the transport time between stages varies, and it is therefore not optimal to rely on timing information alone to determine if a liquid has transported (and this would also necessitate allowing long transport times).

This is often overcome by the use of sensors, but these add time lag to the system and also necessitate the use of extra components.

The invention is directed to the provision of a microfluidic system and method that mitigates some or all of these disadvantages.

The invention in particular seeks to provide a microfluidic system and method for the effective processing for analysis and optionally further the analysis of collected chemical or biological samples successively through plural microfluidic reactors having different functions.

The invention in particular seeks to provide a microfluidic system and method for the effective transportation of a microfluidic sample successively through such plural microfluidic reactors having different functions.

The invention in particular seeks to provide a microfluidic system and method for the effective processing for analysis and optionally further the analysis of collected chemical or biological samples that lends itself to use in close spatial or temporal proximity to a sample collection site, and for example in-line with a collection system.

### SUMMARY OF INVENTION

In accordance with the invention in a most general first aspect, a microfluidic system comprises:
a plurality of fluidly connected microfluidic chambers, each microfluidic chamber comprising:
   a fluid sample inlet;
   a fluid sample outlet;
   a selectably closable valve configured to be operable to enable gas to be vented from the chamber;
a pressurisation system configured to be operable to apply an overpressure to one or more first microfluidic chambers being fluidly most upstream.

Each microfluidic chamber may comprise a microfluidic reactor defining a processing volume and having a processing function, the microfluidic chambers being disposed fluidly successively to enable performance of these functions successively. Each microfluidic chamber comprises a valved outlet configured to be operable to equalise pressure within the chamber when the valve is in an open position, but is otherwise sealed to the ambient environment of the system. A microfluidic chamber may include additional inlets/outlets for reagents and outputs associated with such a function, but these are again so arranged that the chamber is closed to the ambient environment of the system (where ambient environment herein means the environment immediately external to the system, whether that is ambient atmosphere or a closed and for example inert gaseous system).

The system thus comprises a series of individual sealed microfluidic reactors, connected together to form a successive array. Such is familiar. The invention is characterised by the provision of a pressurisation system to apply an overpressure to the first chamber and by the provision in each microfluidic chamber of a valve operable to enables gas to be vented from the microfluidic chamber, and thus operable when open to equalise pressure therein to that of the ambient environment of the system.

In use, the pressurisation system applies an overpressure, preferably a constant overpressure, to at least a first one of the chambers being fluidly most upstream. This creates a constant pressure differential between the fluidly upstream and the fluidly downstream end of the series of chambers. It is then possible, merely by selective opening and closing of the valves, for the fluid sample to be transferred from one chamber to the next, and for example thereby from one process to the next.

This transportation successively through the series of chambers is achieved simply by operation of the valves appropriately sequentially, and by action of the pressurisation. It can be seen that if a chamber has its valve open any overpressure at the inlet is equalised by venting of gas from the chamber, the fluid remains in the chamber and the fluid can be acted upon by the processes of the reactor volume created therein. Once the valve is closed, the build up of pressure in the chamber forces fluid through the outlet of the chamber to an inlet of a subsequent chamber in fluid series thereto, to which the outlet of the preceding chamber is fluidly connected. Thus, a series of microfluidic chambers comprising in the typical case a series of microfluidic reactor volumes can be used to create a microfluidic chain of a series of processes acting upon the fluid.

By analogy, in a second aspect of the invention a microfluidic method comprises: providing a plurality of fluidly connected microfluidic chambers, each microfluidic chamber comprising:
a fluid sample inlet;
a fluid sample outlet;
a selectably closable valve configured to be operable to enable gas to be vented from the chamber;
   and a pressurisation system configured to be operable to apply an overpressure to a one or more first microfluidic chambers being fluidly most upstream;
   supplying a fluid sample to the one or more first microfluidic chambers being fluidly most upstream;
   operating the pressurisation system to apply an overpressure to the one or more first microfluidic chambers;
   selectively operating the valves of the fluidly connected microfluidic chambers to cause the fluid sample to move successively between the microfluidic chambers.

Advantageously, the system of the first aspect and method of the second aspect provide for the transport of a fluid sample through successive microfluidic chambers, for example comprising successive microfluidic reactors, for example having different functions, efficiently and effectively and with few moving parts.

Further advantageously, it is not necessary to sense when a fluid sample has entered a particular chamber, as its position can be determined by the current status and history of the valve operations. Therefore, additional sensors are not required to track the fluid, and there is reduced timing latency in the process.

Further advantageously, the system and method is susceptible to ready automation. The system and method is applicable to the provision of lab-on-chip systems for use at a remote sample collection location for the effective processing for analysis and optionally further the analysis of collected chemical or biological samples in close spatial or temporal proximity to a site, and for example in-line with a collection system.

Preferred features of the two aspects of the invention will be understood from the discussion herein. In particular, preferred and characterising features of the system of the first aspect of the invention, and of its operation, are discussed below. Preferred and characterising features of the steps of the method of the second aspect of the invention will be appreciated by analogy.

References herein to the microfluidic chambers comprising a fluid series, or being connected successively or serially or the like, should not be interpreted as requiring that the invention is limited to a single serial array. The principles of the invention lend themselves to various more complex network arrangements, including arrangements having branching and convergent pathways, arrangements where plural microfluidic chambers are provided in parallel, arrangements including feedback loops and the like.

To apply the principles of the invention to such networks of microfluidic chambers it is merely necessary that there is a fluid sample input side comprising one or more microfluidic chambers operable to receive a fluid sample to be processed, a fluid sample output side comprising one or more microfluidic chambers from which a processed fluid sample can be output, and a network of fluidly connected microfluidic chambers intermediately therebetween, with the pressurisation system being configured to be operable to apply an overpressure to the fluidly most upstream chamber(s) on the fluid sample input side and thereby to create a pressure differential between the fluidly most upstream chambers on the input side and the fluidly most downstream chambers on the output side.

Accordingly, in a typical embodiment of the invention, a microfluidic system comprises a plurality of microfluidic chambers, the chambers comprising a fluidly connected network including: one or more input chambers being fluidly most upstream, each configured such that its fluid sample inlet is disposed to receive a fluid sample to be processed; one or more output chambers being fluidly most downstream, each configured such that its fluid sample outlet is disposed to output a processed fluid sample; a plurality of intermediate chambers, each fluidly disposed between a preceding and a succeeding chamber in the network, such that its fluid sample inlet is connected by a microfluidic pathway to the fluid sample outlet of the preceding chamber, and such that its fluid sample outlet is connected by a microfluidic pathway to a fluid sample inlet of a succeeding chamber; wherein the pressurisation system is operable to apply an overpressure to each input chamber.

A chamber in such a network may be connected to a single such preceding chamber and a single such succeeding chamber, or may become connected to multiple such preceding chambers and/or multiple such succeeding chambers.

In general terms, microfluidics is an established concept and the skilled person would entirely appreciate the difference between the microfluidic conformance of the modules comprising applicant's invention and larger scale laboratory batch process modules. Microfluidic systems include as will be familiar systems that manipulate and transport, mix, separate, or otherwise process low volumes of fluids on a small (typically sub millimetre) scale. Each chamber of the system of the invention is conformed as a microfluidic reactor in that it has some such microfluidic functionality. Each microfluidic chamber defines a reactor volume in which a microfluidic process may be performed, and which may therefore be referred to as a microfluidic reactor. The invention is applicable to known such microfluidic reactors, and in particular preferably comprises multiple reactors with multiple functionalities. Microfluidic flow channels connect the microfluidic reactors.

Each microfluidic chamber in accordance with the principles of the invention has a configuration of fluid sample inlet, fluid sample outlet, and selectively closable valve which are together so arranged that in use, in a condition where an overpressure is being generated at the inlet, where applicable through preceding chambers, that overpressure is equalised by venting of a gas from the chamber when the valve is in an open configuration, but when the valve is in a closed configuration that overpressure tends to cause fluid to be forced from the chamber into the fluid sample outlet and thereby to a succeeding chamber.

In a possible arrangement, the microfluidic chamber is configured to provide the necessary effect by appropriate juxtaposition of the fluid sample inlet, the fluid sample outlet, and the valve. For example, the system is configured for a fixed operational orientation to the horizontal, with a chamber outlet to the valve being positioned uppermost, a fluid sample outlet lowermost, and a fluid sample inlet at an intermediate height, all with reference to that operational orientation.

Additionally or alternatively, other features of configuration of the microfluidic chamber, and/or other secondary actuators, such as for example flow control actuators to selectively limit flow through a fluid sample inlet and/or a fluid sample outlet of a microfluidic chamber, may be provided.

A particularly advantageous feature of the invention is that it allows for multiple different microfluidic processes to be performed at successive reactor stages in a system of the invention.

Thus, in preferred embodiments of the system, at least one of the plurality of fluidly connected microfluidic chambers comprises a microfluidic reactor having a first process functionality, and at least one other of the said microfluidic chambers comprises a microfluidic reactor having a second process functionality different from the first. In yet more preferred embodiments multiple different functionalities may be provided.

In this way, successive process functionalities may be provided in successive chambers. This does not preclude the provision of systems in which multiple chambers also have the same functionality. For example multiple chambers may be provided in series and/or in parallel with equivalent functionality.

In an optional embodiment, the pressurisation system may additionally be operable to apply an overpressure to one or more of the microfluidic chambers being fluidly most downstream.

The intention of this is to allow a constant pressure differential to be created between the fluidly upstream and fluidly downstream end of the series of chambers in an opposite direction, with the higher pressure being at the fluidly downstream end. Advantageously, the direction of travel of the fluid within the system can thus be reversed in use, for example if it is desired to use the processing functions of a given chamber or series of chambers on plural occasions.

The network of microfluidic chambers may include a microfluidic feedback pathway, optionally comprising one or more further microfluidic chambers in the feedback pathway, through which a fluid sample may be sent from a fluidly more downstream chamber to a fluidly more upstream chamber, for example when the pressure differential is in the reverse direction as above described, or otherwise.

it will be understood that where reference in this context is made to a fluidly more downstream side onto a fluidly more upstream side, this is with reference to the primary direction of flow from an initial input of unprocessed fluid to an ultimate output of processed fluid, with the reverse direction referring to the contrary flow, and a reverse pressure differential to a pressure differential comprising an overpressure in this contrary direction.

The pressurisation system for example comprises a pressure source and optionally further a pressure regulator. The pressure source is for example a source of gas under an overpressure relative to an ambient pressure of the system. The pressurisation system for example comprises, and the pressure source is for example, an impeller, which may be configured to be operable to push gas under an overpressure from the environment immediately external to the system into the system and into the chambers to be pressurised.

Advantageously, the system of the invention is particularly suited to being developed as a modular system.

For example, in particular preferred embodiment, the system comprises:
a plurality of microfluidic reactor modules, each including a microfluidic chamber as herein described and optionally further including further components to give the module a particular processing functionality; and
a microfluidic framework into which each microfluidic module may be received to form a system in accordance with the first aspect of the invention.

Conveniently, each such microfluidic module is configured with sufficient structural similarity to be interchangeable within the framework and thereby form a fluidly continuous network of interchangeable modules. In this way, a standard framework may be provided which can be given multiple different functionalities, by interchanging multiple modules with different processing functions, as desired.

### BRIEF DESCRIPTION OF DRAWINGS

The invention will now be described by way of example only with reference to FIGS. 1 to 5 of the accompanying drawings, in which:

FIG. 1 is a simple schematic of a of linear chain of microfluidic reactors in accordance with the principles of the invention with fluid flow left to right;

FIG. 2 shows an example of the application of this concept;

FIG. 3 shows example bioreactors for use in the FIG. 2 example;

FIG. 4 shows a simple schematic of a linear chain of microfluidic reactors with additional reverse fluid flow function;

FIG. 5 shows an application of the FIG. 4 concept to a differently arranged chain of microfluidic reactors.

### DETAILED DESCRIPTION OF PREFERRED EMBODIMENTS

The invention is discussed with reference to simple arrangements of microfluidic reactors, which comprise bioreactors. This is by way of example, and it will be readily understood that the principles of the invention apply to microfluidic processing chambers of any processing functionality, in particular for the processing and preparation for analysis and/or for the analysis of fluidised and for example aqueous chemical and biological samples of any origin. The systems discussed are in particular suited for the automated processing and for example analysis of environmental samples in close proximity to the site of their collection, and for example may be provided in direct fluid association with, and for example in line with, a suitable sample collection system.

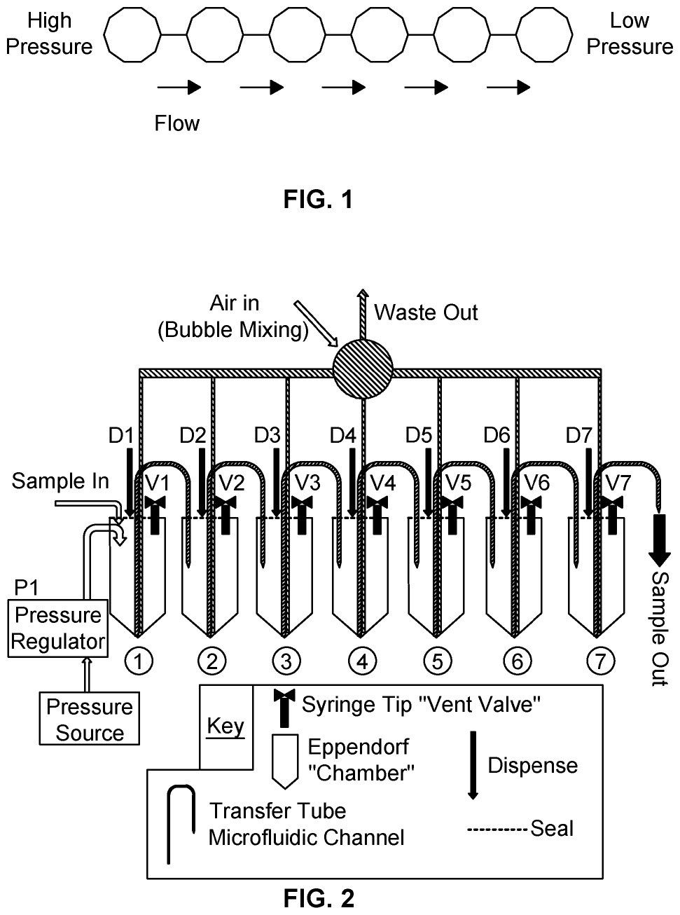

The basic schematic of FIG. 1 shows a simple serial arrangement of individual sealed micro-bioreactors, microfluidically connected together as shown and each with a valve outlet through which, with the valve open, the chamber may be vented (not shown in FIG. 1). Pressure means (not shown in FIG. 1) create a pressure differential with a higher pressure to the left. By having a constant pressure differential at one end of the chain to the other, by opening and closing valves the fluid can be transferred from one bioreactor to the next.

At the first instance, if a bioreactor has its valve open to the ambient the pressure source can force the liquid into the bioreactor via its inlet. With the valve open, the fluid remains in the bioreactor and the fluid can be acted upon by the processes of the bioreactor. Once the valve is closed, the pressure builds up in the bioreactor and the fluid is forced to the outlet of the bioreactor towards the next bioreactor in the chain. Thus a series of bioreactors can be used to create a microfluidics chain of a series of processes acting upon the fluid.

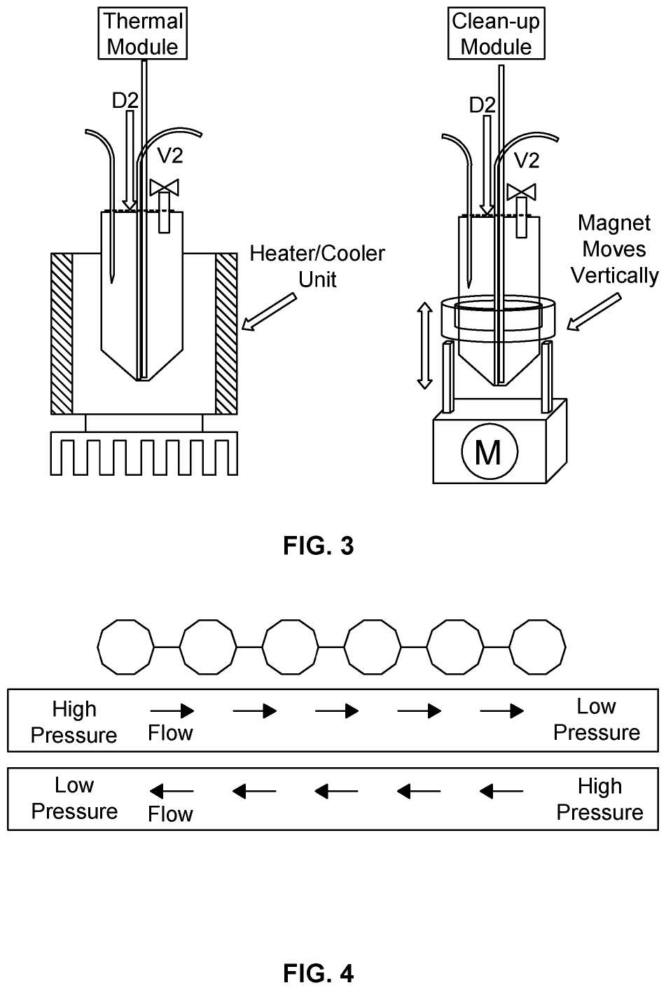

An example set up which shows the valves and the pressure source, which is for example a suitable impeller, is shown in FIG. 2, and example different bioreactors with different functionalities are shown in FIG. 3.

In this basic setup, we implement two or more sealed bioreactors in a series, the a constant pressure source connected to the first reactor, and each bioreactor containing at a minimum an inlet, an outlet and a controllable valve which enables air to be vented out of the bioreactor.

With this setup, it is not necessary to sense when a fluid has entered a particular bioreactor, as its position can be determined by the current and history of the valve open and closed configurations. Therefore, additional sensors are not required to track the fluid, and there is low timing latency in the process.

An optional addition to the bioreactors as shown in FIGS. 2 and 3 is the provision of additional inlets/outlets. For example, a second inlet can permit reagents to be added to a bioreactor, or a second outlet may be used to collect waste materials from the bioreactor. In some embodiments, this could be a fourth connection to the bioreactor acting as both an extra inlet or outlet, or a fourth and fifth connection for dedicated inlets and outlets. Additional inlets and outlets should be designed so they have sufficiently high resistance to prevent fluid escaping when not desired.

In an optional embodiment, the direction of the pressure differential across the series of bioreactors may be switched, so the direction of travel of the fluid can be reversed, for example if it is desired to use the functions of the bioreactor on multiple occasions. This is shown in the simple schematic of FIG. 4.

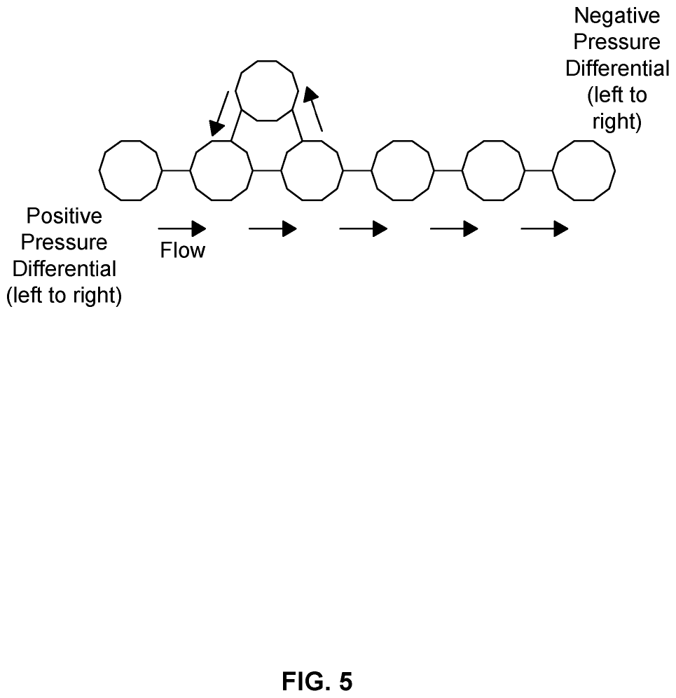

In various optional embodiments, for example to exploit this, the chain of bioreactors may not be linear, but could contain different branches to facilitate multiple uses of the same bioreactor, or the select different routes for the fluid to take depending upon the outcomes in earlier bioreactors. A refinement, shown in FIG. 5, builds in a reverse microfluidic flow path, in this case including a further bioreactor, through means of which flow in the reverse direction may be effected.

1. A microfluidic system comprising:
a plurality of fluidly connected microfluidic chambers, each microfluidic chamber comprising:
a fluid sample inlet;
a fluid sample outlet;
a selectably closable valve operable to enable gas to be vented from the chamber;
a pressurisation system operable to apply an overpressure to one or more first microfluidic chambers being fluidly most upstream.

2. The microfluidic system according to claim 1 wherein each microfluidic chamber comprises a microfluidic reactor defining a processing volume and having a processing function, the microfluidic chambers being disposed fluidly successively to enable performance of these functions successively.

3. The microfluidic system according to claim 1 wherein each microfluidic chamber includes additional inlets/outlets but is otherwise sealed to the ambient environment of the system.

4. The microfluidic system according to claim 1 defining a fluid sample input side comprising one or more microfluidic chambers operable to receive a fluid sample to be processed, a fluid sample output side comprising one or more microfluidic chambers from which a processed fluid sample can be output, and a network of fluidly connected microfluidic chambers intermediately therebetween, with the pressurisation system being configured to be operable to apply an overpressure to the one or more microfluidic chambers on the fluid sample input side.

5. The microfluidic system according to claim 1 comprising a plurality of microfluidic chambers, the chambers comprising a fluidly connected network including: one or more input chambers being fluidly most upstream, each configured such that its fluid sample inlet is disposed to receive a fluid sample to be processed;
one or more output chambers being fluidly most downstream, each configured such that its fluid sample outlet is disposed to output a processed fluid sample;
a plurality of intermediate chambers, each fluidly disposed between a preceding and a succeeding chamber in the network, such that its fluid sample inlet is connected by a microfluidic pathway to the fluid sample outlet of the preceding chamber, and such that its fluid sample outlet is connected by a microfluidic pathway to a fluid sample inlet of a succeeding chamber;
wherein the pressurisation system is operable to apply an overpressure to each input chamber.

6. The microfluidic system according to claim 1 wherein each microfluidic chamber has a configuration of fluid sample inlet, fluid sample outlet, and selectively closable valve together so arranged that in use, in a condition where an overpressure is being generated at the inlet, where applicable through preceding chambers, that overpressure is equalised by venting of a gas from the chamber when the valve is in an open configuration, but when the valve is in a closed configuration that overpressure tends to cause fluid to be forced from the chamber into the fluid sample outlet and thereby to a succeeding chamber.

7. The microfluidic system according to claim 1 wherein the system is configured for a fixed operational orientation to the horizontal and each microfluidic chamber has a configuration of fluid sample inlet, fluid sample outlet, and selectively closable valve such that the valve is positioned uppermost, the fluid sample outlet lowermost, and the fluid sample inlet at an intermediate height.

8. The microfluidic system according to claim 1 wherein at least one of the plurality of fluidly connected microfluidic chambers comprises a microfluidic reactor having a first process functionality, and at least one other of the said microfluidic chambers comprises a microfluidic reactor having a second process functionality different from the first process functionality.

9. The microfluidic system according to claim 1 wherein the pressurisation system is additionally operable to apply an overpressure to one or more of the microfluidic chambers being fluidly most downstream.

10. The microfluidic system according to claim 1 wherein the microfluidic chambers form a network including a microfluidic feedback pathway, optionally comprising one or more further microfluidic chambers in the feedback pathway, through which a fluid sample may be sent from a fluidly more downstream chamber to a fluidly more upstream chamber.

11. The microfluidic system according to claim 1 wherein the pressurisation system comprises a source of gas under an overpressure relative to an ambient pressure of the system.

12. The microfluidic system according to claim 11 wherein the pressurisation system comprises an impeller, operable to push gas under an overpressure from the environment immediately external to the system into the system.

13. The microfluidic system according to claim 1 comprising:
a plurality of microfluidic reactor modules, each including a microfluidic chamber; and
a microfluidic framework into which each microfluidic module may be received to form a system in accordance with according to any preceding claim.

14. The microfluidic system according to claim 13 wherein each microfluidic module is configured with sufficient structural similarity to be interchangeable within the framework and thereby form a fluidly continuous network of interchangeable modules.

15. A microfluidic method comprising:
providing a microfluidic system according to any preceding claim;
supplying a fluid sample to the one or more first microfluidic chambers being fluidly most upstream;
operating the pressurisation system to apply an overpressure to the one or more first microfluidic chambers;
selectively operating the valves of the fluidly connected microfluidic chambers to cause the fluid sample to move successively between the microfluidic chambers.
